(19) United States
(12) Patent Application Publication
(10) Pub. No.: US 2025/0030285 A1
(43) Pub. Date: Jan. 23, 2025

(54) Permanent-Magnet Rotor and Permanent-Magnet Motor for a Motor Vehicle

(71) Applicant: Bayerische Motoren Werke Aktiengesellschaft, Muenchen (DE)

(72) Inventor: Rafael SABAINI, Wolfern (AT)

(21) Appl. No.: 18/777,743

(22) Filed: Jul. 19, 2024

(30) Foreign Application Priority Data
Jul. 21, 2023 (DE) 10 2023 119 259.0

(51) Int. Cl. H02K 1/27; H02K 1/28

(52) U.S. Cl. CPC H02K 1/27; H02K 1/28

(57) ABSTRACT

A permanent-magnet rotor for a permanent-magnet motor includes a laminated core, receiving pockets which are formed in the laminated core, and permanent magnets which are each accommodated in segmented form in one of the receiving pockets. The permanent magnets have at least one asymmetrically segmented permanent magnet, which is segmented only in an end region which is arranged facing away from an axis of rotation of the permanent-magnet rotor.

### CROSS REFERENCE TO RELATED APPLICATION

This application claims priority under 35 U.S.C. § 119 from German Patent Application No. 10 2023 119 259.0, filed Jul. 21, 2023, the entire disclosure of which is herein expressly incorporated by reference.

### BACKGROUND AND SUMMARY

The present disclosure relates to a permanent-magnet rotor, to a permanent-magnet motor having the permanent-magnet rotor, and/or to a motor vehicle having the permanent-magnet motor.

Electric motors can be used in motor vehicles, for example as traction machines. In electric motors, various designs are known, for example synchronous motors. This is understood to mean a single-phase and three-phase synchronous machine in motor mode, in which in normal operation a constantly magnetized rotor is driven synchronously by a moved magnetic rotational field in the stator. The rotor can have permanent magnets or electromagnets for constant magnetization.

The energy provided by the magnetic interaction between the stator and the rotor can be tapped off via the rotation of the rotor and, for example, used to drive the electrically driveable motor vehicle or another machine in the motor vehicle.

If the rotor has permanent magnets, these are usually accommodated in an active part of the rotor, which is normally designed as a laminated core. The permanent magnets are often segmented in order to reduce the eddy-current losses. The segmentation is usually carried out in an axial segmentation, i.e. a plurality of magnetic segments are inserted axially into the rotor laminated core.

To further reduce the losses, the permanent magnets can, however, also be segmented tangentially, wherein the segments are, for example, placed loosely into the rotor during the assembly or are initially bonded outside the motor and then inserted into the rotor.

During the production of the permanent magnets, these are usually sintered in large blocks and brought to the desired size by cutting. However, the segmentation increases the production outlay and also the quantity of magnetic waste.

DE 10 2021 206 967 A1 describes a permanent-magnet motor, comprising a rotor assembly which defines magnet pockets, and a segmented permanent magnet which is arranged in each of the magnet pockets. The permanent magnet comprises a large number of magnet segments, including one or more magnet segments which have a different magnetic material from another magnet segment or segments. The segmented permanent magnet is segmented in a circumferential direction.

WO 2022/121276 A1 describes a V-shaped segmented permanent-magnet synchronous electric motor rotor. A large number of permanent magnet units are arranged on an iron rotor core of the rotor and symmetrically about the axis of the iron rotor core. Each permanent magnet unit comprises a V-shaped magnetic steel combination of a magnetic steel unit and two magnetic steel segments having different widths, wherein the magnetic steel unit and the two magnetic steel segments are arranged in a V shape.

DE 10 2011 078 054 A1 describes a laminated core for a rotor of an electric machine, which has a plurality of lamellas arranged one after another in the axial direction. A plurality of receptacle spaces for receiving permanent magnets are formed in the laminated core.

Against the background of this prior art, an object of the present disclosure consists in specifying a device and/or a method which are respectively suitable to enhance the prior art.

This object is achieved by the features disclosed herein. The present disclosure also includes optional developments of the disclosure as content.

According to the latter, this object is achieved by a permanent-magnet rotor for a permanent-magnet motor.

The permanent-magnet rotor comprises a laminated core and receiving pockets which are formed in the laminated core. The permanent-magnet rotor can comprise a rotor shaft, wherein the laminated core can be designed as part of the rotor shaft or can be arranged on the rotor shaft, e.g. surrounding the rotor shaft circumferentially.

The permanent-magnet rotor comprises permanent magnets which are each accommodated in segmented form in one of the receiving pockets.

The permanent magnets have at least one asymmetrically segmented permanent magnet, which is segmented only on an end region, which is arranged facing away from an axis of rotation of the permanent-magnet rotor.

The above-described permanent-magnet rotor offers a series of advantages. For example, during the development of the present disclosure, amongst other things using simulations, it has been established that the eddy-current losses are concentrated in particular in the respective end region of the permanent magnets which faces the stator of the motor and faces away from the axis of rotation of the permanent-magnet rotor. As a result of the segmentation only in this end region, the effectiveness with regard to the reduction of eddy-current losses is therefore reduced only by a small amount in comparison with, for example, symmetrical segmentation. At the same time, the production outlay for the permanent-magnet rotor and of the segmented permanent magnets is reduced by the reduced number of segmentations. In addition, the magnetic waste during the production can also advantageously be reduced as a result. These advantages, which occur from the point of view of time and costs during the production, overcome the disadvantage as a result of the effectiveness reduced by a small amount by the segmentation. Thus, the present disclosure offers cost-optimized magnet segmentation to reduce the losses in a permanent-magnet rotor.

Possible developments of the above-described permanent-magnet rotor are explained in detail below.

The permanent magnets can each have segment portions. The permanent magnets can be segmented in such a way that the respective segment portions are arranged beside one another in a direction which (for example in a cross-sectional plane of the permanent-magnet rotor or the laminated core) extends obliquely, radially and/or tangentially to the axis of rotation of the permanent-magnet rotor.

The permanent magnets can be plate-shaped.

A respective width or length direction of the permanent magnets can (for example in a cross-sectional plane of the permanent-magnet rotor or the laminated core) extend in the direction obliquely, radially and/or tangentially to the axis of rotation of the permanent-magnet rotor.

A respective length, width or height direction of the permanent magnets can extend in the axial direction of the permanent-magnet rotor.

The respective segment portions can be connected and/or bonded to one another.

The at least one asymmetrically segmented permanent magnet can have a poka yoke safeguard in the end region. The poka yoke safeguard can be used for the positionally accurate and correct assembly of the at least one asymmetrically segmented permanent magnet in the permanent-magnet rotor.

An outermost segment portion of the asymmetrically segmented permanent magnet can have a step. The poka yoke safeguard can be arranged within the step to produce a form fit between the outermost segment portion and the laminated core.

The poka yoke safeguard can be designed as a nose and/or clamping nose.

The permanent magnets can be clamped (and/or accommodated in a clamped manner) in the receiving pockets.

In each case a plurality of the receiving pockets can be formed one after another in the radial direction of the permanent-magnet rotor.

The permanent magnets can have a plurality of asymmetrically segmented permanent magnets. It is also conceivable that all the permanent magnets can be designed as asymmetrically segmented permanent magnets.

The permanent magnets can be arranged in a pattern which repeats in the circumferential direction and/or in the axial direction of the permanent-magnet rotor.

A plurality of the permanent magnets can be arranged after one another in the axial direction of the permanent-magnet rotor. Alternatively or additionally, at least some of the permanent magnets can also be segmented, for example symmetrically, in the axial direction of the permanent-magnet rotor.

That which was described above can be summarized in other words and in a possible more specific configuration of the disclosure as described below, wherein the following description is not to be construed as restrictive for the disclosure.

Using simulations, it has been established that losses in permanent magnets of a rotor are concentrated in the edge region of the permanent magnets that faces the stator. Therefore, for example from the point of view of costs, provision can be made to implement tangential and/or radial segmentation only in just this edge region, i.e. to segment permanent magnets asymmetrically.

To ensure the positionally accurate assembly of the permanent magnets (with positioning of the segmented regions in the direction of the stator), a poka yoke safeguard can be provided (in each case). For example, one or more segments can be formed geometrically without any noticeable cost disadvantage such that a poka yoke safeguard can be implemented, for example a step in a segment.

This can result in a further advantage, since, by means of the step in the permanent magnet, an additional degree of design freedom is made possible in the laminated core cross section, which is highly loaded at this point. As a result of the step, less magnet mass can be lost (and therefore a low reduction in torque), wherein the degree of freedom can be created to partially thicken the highly loaded laminated core cross section or to enlarge (tangent-continuous) radii and thus to reduce loading hotspots.

In addition, a permanent-magnet motor, optionally a permanent-magnet synchronous motor and/or self-excited synchronous motor, for a motor vehicle, which comprises the above-described permanent-magnet rotor, is provided.

The permanent-magnet motor can comprise a stator which surrounds the permanent-magnet rotor at least circumferentially or in the circumferential direction.

The stator can have a plurality of electric coils, to which an alternating current and/or three-phase current can be applied to drive the permanent-magnet rotor.

The permanent-magnet motor can be operable in motor mode and/or generator mode. The permanent-magnet motor can also be designated an electric machine.

That which was described above with reference to the permanent-magnet rotor also applies analogously to the permanent-magnet motor and vice versa.

Also provided is a motor vehicle which comprises the above-described permanent-magnet motor and/or the above-described permanent-magnet rotor.

The motor vehicle can be an electrically driveable, e.g. movable, motor vehicle. The permanent-magnet motor can be designed as a traction motor or traction machine of the motor vehicle. The motor vehicle can comprise a traction battery, for example to apply electrical energy, or an alternating current via at least one converter, to the stator.

The motor vehicle can be a passenger car, in particular an automobile, or a utility vehicle, such as a truck.

That which was described above with reference to the permanent-magnet motor and to the permanent-magnet rotor also applies analogously to the motor vehicle and vice versa.

Optional embodiments will be described below with reference to FIGS. 1 and 2.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows, schematically, a detail of a permanent-magnet rotor according to the disclosure, and

FIG. 2 shows, schematically, a detail of the permanent-magnet rotor according to a further embodiment.

### DETAILED DESCRIPTION OF THE DRAWINGS

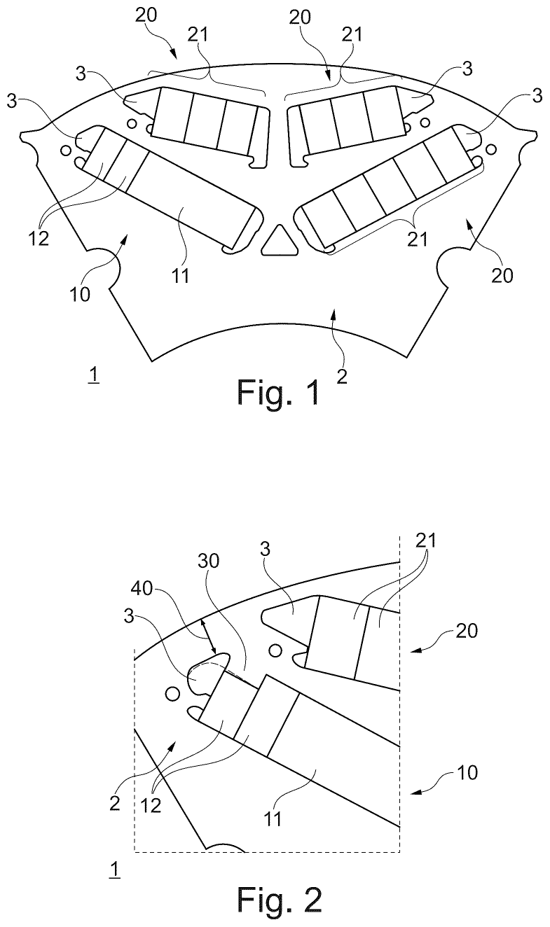

FIG. 1 shows, purely schematically and as a detail, the permanent-magnet rotor 1 for a permanent-magnet motor, for example of a motor vehicle. The permanent-magnet rotor 1 comprises a laminated core 2 and receiving pockets 3 which are formed in the laminated core 2.

The permanent-magnet rotor 1 also comprises permanent magnets 10, 20, which are each accommodated, for example in a clamped manner, in segmented form in one of the receiving pockets 3.

The receiving pockets 3 can be formed in such a way and the permanent magnets 10, 20 can be arranged in such a way that in each case a plurality of the receiving pockets 3 are formed one after another in the radial direction of the permanent-magnet rotor 1.

The permanent-magnet rotor 1 has at least one asymmetrically segmented permanent magnet 10, which is segmented only in an end region which is arranged facing away from an axis of rotation of the permanent-magnet rotor 1. The permanent-magnet rotor 1 can correspondingly have one or more symmetrically segmented permanent magnets 20.

It is conceivable that a plurality or even all of the permanent magnets of the permanent-magnet rotor 1 are segmented asymmetrically.

The permanent magnets 10, 20 each have a plurality of segment portions 11, 12, 21, wherein the permanent magnets 10, 20 are segmented in such a way that the respective segment portions 11, 12, 21 are arranged beside one another in a direction which extends, for example in a cross-sectional plane of the permanent-magnet rotor 1, obliquely, radially and/or tangentially to the axis of rotation of the permanent-magnet rotor 1.

The permanent magnets 10, 20 can be plate-shaped here. In addition, the permanent magnets 10, 20 can be arranged in such a way that a respective width or length direction of the permanent magnets 10, 20 extends in the direction obliquely, radially and/or tangentially to the axis of rotation of the permanent-magnet rotor 1, and a respective length, width or height direction of the permanent magnets 10, 20 extends in the axial direction of the permanent-magnet rotor 1.

Furthermore, the respective segment portions 11, 12, 21 can be connected to one another, for example bonded, in order to form the permanent magnets 10, 20.

The arrangement of the permanent magnets 10, 20 illustrated in FIG. 1 can correspond to an arrangement pattern which repeats in the circumferential direction of the permanent-magnet rotor 1. In addition, this arrangement can also repeat in the axial direction of the permanent-magnet rotor 1, for example at equal intervals.

As is shown schematically in FIG. 2, in one embodiment the at least one asymmetrically segmented permanent magnet 10 has a poka yoke safeguard 30 in the end region.

For this purpose, an outermost segment portion 12 of the asymmetrically segmented permanent magnet 10 has a step, wherein the poka yoke safeguard 30 is arranged within the step to produce a form fit between the outermost segment portion 12 and the permanent-magnet rotor 1. The poka yoke safeguard 30 can be designed, for example, as a nose and/or clamping nose. The poka yoke safeguard 30 can be implemented on the laminated core 2 and/or as a part of the laminated core 2.

The poka yoke safeguard 30 is used to ensure the positionally accurate assembly of the asymmetrically segmented permanent magnet 10, the segmented end region being correctly arranged facing away from the axis of rotation of the permanent-magnet rotor 1. The outermost segment portion 12 can be formed here geometrically without any noticeable cost disadvantage by forming, for example, the step.

As a result of the poka yoke safeguard 30 and the step that is formed, the result is also the advantage of an additional degree of design freedom in the region of a highly loaded cross section 40 of the laminated core 2. For example, this cross section 40 can, at least partly, have a greater thickness or the receiving pocket 3 in this region can have another radius, for example a larger radius, in order, for example, to reduce the loading as a result.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF DESIGNATIONS

1 Permanent-magnet rotor
2 Laminated core
3 Receiving pockets
10 Asymmetrically segmented permanent magnet
20 (Symmetrically segmented) permanent magnets
11, 12, 21 Segment portions
30 Poka yoke safeguard
40 Highly loaded cross section of the laminated core

What is claimed is:

1. A permanent-magnet rotor for a permanent-magnet motor, comprising:
a laminated core;
receiving pockets, which are formed in the laminated core; and
permanent magnets, which are each accommodated in segmented form in one of the receiving pockets,
wherein the permanent magnets have at least one asymmetrically segmented permanent magnet, which is segmented only in an end region which is arranged facing away from an axis of rotation of the permanent-magnet rotor.

2. The permanent-magnet rotor according to claim 1, wherein the permanent magnets each have segment portions and are segmented in such a way that the respective segment portions are arranged beside one another in a direction which extends obliquely, radially and/or tangentially to the axis of rotation of the permanent-magnet rotor.

3. The permanent-magnet rotor according to claim 2, wherein
the permanent magnets are plate-shaped,
a respective width or length direction of the permanent magnets extends in the direction obliquely, radially and/or tangentially to the axis of rotation of the permanent-magnet rotor,
a respective length, width or height direction of the permanent magnets extends in an axial direction of the permanent-magnet rotor, and
the respective segment portions are connected and/or bonded to each other.

4. The permanent-magnet rotor according to claim 1, wherein the at least one asymmetrically segmented permanent magnet has a poka yoke safeguard in the end region.

5. The permanent-magnet rotor according to claim 4, wherein
an outermost segment portion of the asymmetrically segmented permanent magnet has a step, and
the poka yoke safeguard is arranged within the step to produce a form fit between the outermost segment portion and the laminated core.

6. The permanent-magnet rotor according to claim 4, wherein the poka yoke safeguard is designed as a nose and/or clamping nose.

7. The permanent-magnet rotor according to claim 1, wherein the permanent magnets are clamped in the receiving pockets.

8. The permanent-magnet rotor according to claim 1, wherein in each case a plurality of the receiving pockets are formed one after another in a radial direction of the permanent-magnet rotor.

9. A permanent-magnet motor for a motor vehicle, comprising:
the permanent-magnet rotor according to claim 1.

10. A motor vehicle comprising:
the permanent-magnet motor according to claim 9.
